(19) United States
(12) Patent Application Publication
(10) Pub. No.: US 2015/0251838 A1
(43) Pub. Date: Sep. 10, 2015

(54) System and Method for Heating Items

(71) Applicant: Dave Huselton, Fleming Island, FL (US)

(72) Inventor: Dave Huselton, Fleming Island, FL (US)

(21) Appl. No.: 14/641,312

(22) Filed: Mar. 7, 2015

Related U.S. Application Data
(60) Provisional application No. 61/949,410, filed on Mar. 7, 2014.

(51) Int. Cl. B65D 81/34; A47J 36/28; F24J 1/00

(52) U.S. Cl. CPC B65D 81/3484; F24J 1/00; A47J 36/28

(57) ABSTRACT

A heating element is contained within a resealable heating bag. At least one degassing valve is embedded in the surface of the heating bag, providing for a way for steam to be released from the interior of the bag. The heating element comprises powdered aluminum, calcium oxide, calcium carbonate, calcium dihydroxide, sodium carbonate and sodium hydroxide that is reacted with water in a two stage chemical reaction to create heat within the heating bag. The element and the heat generated by the heating element is transferred to a packaged food item placed within the heating bag, thereby heating the food item to a desired temperature. The timing and the heat/pressure level of the cooking process inside the sealed bag can be controlled by correlating the interior space of the heating bag and the size of the element and number of degassing valves embedded in the surface of the heating bag.

### BACKGROUND OF THE INVENTION

1. Technical Field

The present invention generally relates to the field of food preparation and relates more specifically to expedient food preparation techniques and methods.

2. Background Art

Various types of food rations for emergency and contingency situations have been made available for use by military and civilian populations over the years. For example, the Meal, Ready-to-Eat (more commonly known as the “MRE”) is a self-contained, individual field ration in lightweight packaging bought by the United States military for its service members for use in combat or other field conditions where organized food facilities are not available. The MRE replaced the canned Meal, Combat, Individual or “MCI” rations in 1981 and is also the successor to the lighter Long Range Patrol or “LRP” ration developed by the United States Army for Special Forces and Ranger patrol units in Vietnam.

The main purpose of these types of rations is to provide nourishment for individuals who do not have access to more traditional food supplies and preparation facilities. While the MRE and similar emergency food supplies meet basic nutritional needs, the flavor, texture, color, etc. will make for a less than desirable dining experience for many individuals. Particularly, eating cold spaghetti and meatballs, or cold stew, etc. is usually not a dining occasion that is anticipated by many individuals. Accordingly, many methods to improve the MRE eating experience have been attempted over the years, with many of the processes involving the field heating of the MRE.

For example, many MREs are now packaged with a flameless heater. The flameless heater uses a simple chemical reaction to provide sufficient heat to warm the MRE to a more desirable level. The idea behind a typical flameless heater is to use the oxidation of a metal (e.g., iron or magnesium) to generate heat through a chemical reaction. Magnesium metal generally works better than iron because it oxidizes or “rusts” much more quickly. To make a typical flameless heater, magnesium dust is mixed with salt and a little iron dust in a thin, flexible pad about the size of a playing card. To activate the heater, a user will add a little water. Within seconds, the water in the flameless heater reaches the boiling point and is bubbling and steaming. To heat the meal, the user simply inserts the heater and the MRE pouch back in the box that the pouch came in and the MRE is heated to a more desirable level prior to consumption.

One well-known flameless heating package is shown in U.S. Pat. No. 5,465,707. This patent provides the basic details for a structural package used for heating MREs and similar food packages. A well-known construction for a flameless heater element is shown in U.S. Pat. No. 4,522,190 issued to Kuhn. Still another is shown in U.S. Pat. No. 5,611,329 issued to Lamensdorf. In the Kuhn patent, a flameless heater comprised of an exothermic super-corrosive alloy of magnesium and iron is sintered into large single shapes that generally conform to the container for the product. In the Lamensdorf patent, instead of being incorporated into a large sintered body, the super-corrosive alloy is a fine powder contained loosely in a shaped container. The shaped container is adapted to hold portions of the powder in defined regions.

While these various approaches to heating an MRE have had some success and provides a meal that is at least not cold, it is not possible to sustain the heating process for a long enough period of time to heat or cook all types of food. Accordingly, without additional improvements in the systems and methods used in food preparation for emergency and expedient circumstances, the results from preparation of food and beverages in harsh or extreme environments will continue to be suboptimal.

### BRIEF SUMMARY OF THE INVENTION

For the most preferred embodiments of the present invention, a chemically reactive heating element is contained within a heating bag. The heating element comprises a plurality of effective ingredients including powdered aluminum, calcium oxide, calcium carbonate, calcium dihydroxide, sodium carbonate and sodium hydroxide. The heating bag generally comprises a zip lock style closure at the top of the heating bag and at least one degassing valve embedded in the surface of the body of the heating bag. Water is placed inside the heating bag so that it contacts the element to create a chemical reaction. The liquid and/or the food to be cooked or heated is containerized in a separate packaging material and also placed inside the bag where the heat and the steam generated by the heating element will heat and/or cook the food or liquid placed inside the heating bag.

The heating element reacts with the water in a two stage chemical reaction to create heat, steam, and pressure within the heating bag. The heat and steam generated by the heating element is transferred to the packaged water and/or food, thereby heating it to a desired temperature. The timing and the heat/pressure level of the cooking process inside the sealed bag can be controlled by correlating: i) the interior space of the heating bag; ii) the size of the element; and iii) the number of degassing valves embedded in the surface of the heating bag. A larger element will generate more heat and pressure. A greater number of degassing valves will reduce the amount of pressure buildup in the bag.

### BRIEF DESCRIPTION OF THE FIGURES

The preferred embodiments of the present invention will hereinafter be described in conjunction with the appended drawings, wherein like designations denote like elements, and:

FIG. 1 is a perspective view of a heating bag in accordance with a preferred exemplary embodiment of the present invention;

FIG. 2 is a perspective view of a degassing valve in accordance with a preferred exemplary embodiment of the present invention;

FIG. 3; is a plan view of a flattened heating bag in accordance with a preferred exemplary embodiment of the present invention; and

FIG. 4 is a flow chart of a method for using a heating bag in accordance with a preferred exemplary embodiment of the present invention.

### DETAILED DESCRIPTION

A heating bag, containing a heating element is that is reacted with water to generate a chemical reaction to create heat and/or steam in a multi-stage chemical reaction process. The most preferred embodiments of the present invention comprise a heating element with 30% to 45% of powdered aluminum, 10% to 20% of powdered calcium oxide, 15% to 25% powdered calcium carbonate, 10% to 15% calcium dihydroxide, 10% to 15% powdered sodium carbonate and 0.1% to 1% of sodium hydroxide on the basis of the total weight of the heating element (approximately 50 g) that is contacted with approximately 6 oz (177.44 ml) of water to react the powdered calcium with water in a first reaction step to generate heat of reaction.

The calcium hydroxide, calcium dihydroxide, powdered sodium carbonate, and sodium hydroxide is reacted in a second reaction step with the powdered aluminum to generate heat of reaction to make use of approximately 3886 cal/g as the sum of the heat of reaction generated at the first reaction step and second reaction step, which can achieve temperatures of approximately 212° F. (100° C.). Temperatures above 200° F. can be maintained for at least 25 minutes, and temperatures above 175° F. can be maintained for at least 50 minutes. The maintenance of high temperatures over an extended period of time serve to create a flameless pressurized heating bag.

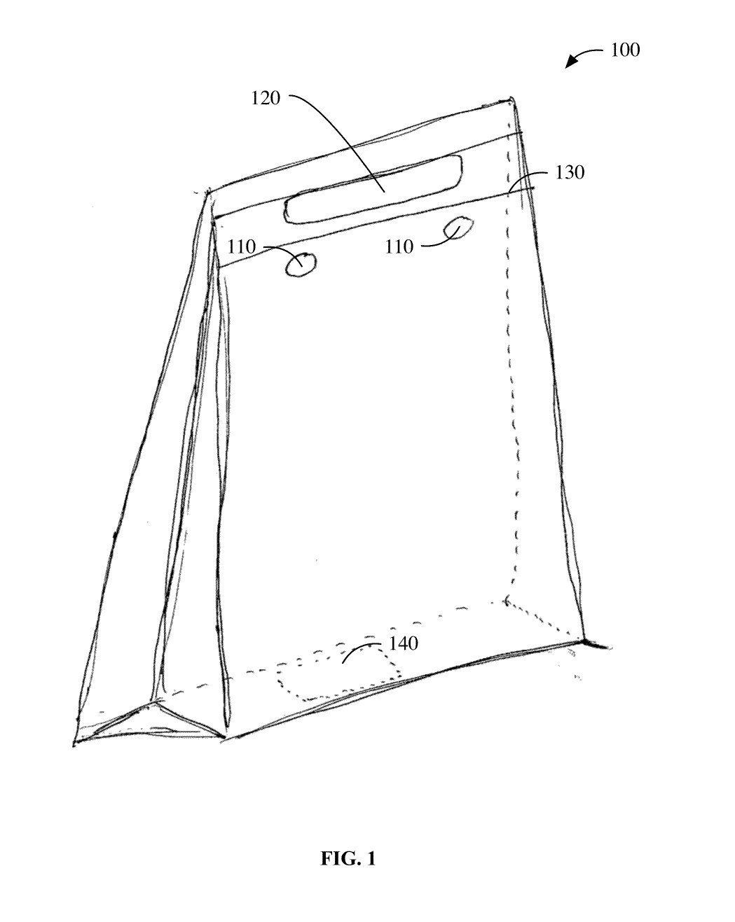

Referring now to FIG. 1, a heating bag 100 in accordance with a preferred exemplary embodiment of the present invention is depicted. As shown in FIG. 1, the most preferred embodiments of heating bag 100 comprise a gusseted polyethylene blend bag. The most preferred heating bag will comprise a bag with a wall thickness of approximately 4 mil (e.g., 0.004 inches) with approximately 325 cubic inches of interior volume, with a selectively sealable heavy duty zip-lock closure top. The bag has one or more degassing valves 110 without the typical filter backing Degassing valves 110, with the filter removed, allow the pressure and heat to remain in the bag over a period of time.

In addition, there is most preferably a zip lock closure 130 or other re-sealable type of closure at the top portion of heating bag 100. Further, an aperture 120 may be formed in the top portion of heating bag 100 so as to provide a convenient way to carry or transport heating bag 100. Additionally, aperture 120 may be used in conjunction with a stick, pole or other similar object so as to hang or suspend heating bag 100 in a desired location.

The most preferred embodiments of the present invention will contain an element 140 that is capable of maintaining the interior steam levels inside the heating bag at a temperature above 175° F. (82.22° C.) for a minimum of 50 minutes. The ratio of a 50 g element with a 325 cubic inches interior bag volume can be adjusted according to the size of bag needed. The degassing valves are most preferably included at a ratio of one degassing valve/100 cubic inches of interior bag volume. The ratio of water is most preferably maintained at 6 oz (177.44 ml). water/50 g element. If a larger heating element is need for a larger volume heating bag, the number of degassing valves can be increased as well to maintain the desired pressure and temperature levels within the heating bag.

The most preferred embodiments of the present invention comprise a heating element 140 containing aluminum powder combined with calcium oxide and other components. The reaction mechanism between the reaction of water with calcium oxide and the reaction mechanism between the reaction of the calcium hydroxide formed by the reaction of calcium oxide with water at the first step with aluminum at the second step. Calcium oxide is reacted with water according to the following reaction formula to form calcium oxide while generating a large quantity of heat; Ca0+H₂O—Ca (OH)₂+15.2 Kcal. The caloric value 15.2 Kcal is divided by 56.08, that is, a molecular weight of CaO to obtain 271 cal/g. As a result of the reaction, an aqueous solution is made strongly alkaline by hydrolysis of calcium hydroxide prepared.

On the other hand, powdered aluminum is reacted rapidly with calcium hydroxide according to the following formula to form calcium aluminate and hydrogen: 2Al+3 Ca (OH)₂=3Ca 0.Al₂O₃+3H₂t. The heat of the reaction generated at the reaction is approximately 47 Kcal which is divided by 13, that is, a molecular weight of Al to obtain approximately 3615 cal/g. Accordingly, approximately 3886 cal of quantity of heat can be obtained by using 1 g of powdered calcium oxide and 1 g of powdered aluminum. That is to say, according to this invention, two step-reactions are carried out in which calcium oxide and water are reacted at the first step, then calcium hydroxide formed at the first step and powdered aluminum are reacted in the second. In other words, it could be understood that calcium hydroxide formed by the reaction of calcium oxide with water serves as a kind of initiator for reacting powdered aluminum at temperatures below 100° C.

The calcium aluminate formed at the reaction cannot be illustrated by a single chemical formula, but rather illustrated by CaO.Al₂O₃, Ca₃[Al (OH)₆]₂, 2Ca (OH)₂.Al (OH)₃5/2H₂O, Ca02Al₂O₃ and so on. It should be, therefore, understood that the chemical formula set forth herein is but one possible reaction of aluminum with calcium hydroxide.

An important consideration for the proper design of the heating element used in the most preferred embodiments of the present invention is that the reaction temperature rises rapidly to temperatures of 90° C. and above immediately after the first step reaction, that is, the reaction of calcium oxide with water and that the temperatures are maintained for at least 50 minutes. Another important consideration for the heating element of the various preferred embodiments of the present invention is that it maintains these heating temperatures for this extended time period because of the degassing valves in the heating bag. The degassing valves are important to maintain the desired levels of temperature, pressure, and steam within the heating bag temperature for longer periods of time. This allows the various preferred embodiments of the invention to not only heat foods, but also cook food within the heating bag, thereby providing more options for a wider variety of foods to be prepared under expedient conditions.

Calcium oxide used in the most preferred embodiments of the present invention is a calcium oxide having 90% and above of CaO content, 3.2% and below of impurities and 2.0% and below of CO₂, more preferably calcium oxide having 93% and above of CaO content, 3.2% and below of impurities and 2.0% and below of CO₂, most preferably calcium oxide having 95% and above of CaO content, 1.8% and below of impurities and 0.9% and below of CO₂.

In general, the smaller the grain size of calcium oxide used, the more rapid the rate of reaction that can be acheived. However, the smaller grain size of calcium oxide is most difficult to work with while maintaining appropriate ratios. Accordingly, the most preferable particle size of calcium oxide used in the most preferred embodiments of the present invention is within a range from 100 mesh (90% and above of −150/inn) to 200 mesh (95% and above of −750/inn).

Aluminum powder having 99.7% and above of Al metal purity, 0.8 to 1.11 g/cm³ of apparent density, and particle size distribution in which −330 mesh (−45/inn) is 40 to 60%, +330 mesh (+45/inn) is 15 to 30%, +235 mesh (+63/inn), is the most preferable in this invention taking the reaction rate, easiness in handle and cost into consideration.

The blend of powdered aluminum, calcium oxide, calcium carbonate, calcium dihydroxide, sodium carbonate and sodium hydroxide specified above is most preferably contained within a non-woven porous pouch, and is called the “element.” The element is placed in a waterproof bag, such as a sealed bag manufactured from aluminum foil wrap such as PET12/AL7/LLDPE40 material. This material wrap keeps the element 100% moisture and air proof. It is anticipated that when the element is wrapped in the foil PET12/AL7/LLDPE40 material, it can be submerged under water for up to 40 hours without compromising the integrity of heating element 140. Heating element 140 is taken out of the protective wrapper and placed inside heating bag when ready to use. For the most prefer red embodiments of element 140, the powdered aluminum, calcium oxide, calcium carbonate, calcium dihydroxide, sodium carbonate and sodium hydroxide are pre-mixed to the preferred ratio specifications and then contained within a non-woven fabric pouch. When approximately 6 oz. of water is put into the bag with the 50 g element, the chemical reaction will generally start within 20 seconds. The chemical interaction creates boiling water and creates hot steam for heating and/or cooking the contents of an item that has been place inside the interior space of the heating bag where heating etc cant 140 is located.

The gusset on the bottom of heating bag 100 is proved for two main purposes. First is to allow heating bag 140 to be stored flat yet to stand on its own so that it won't fall over when it is to be used. Second it lets element 140 fit squarely on the bottom of the bag for the most efficient performance.

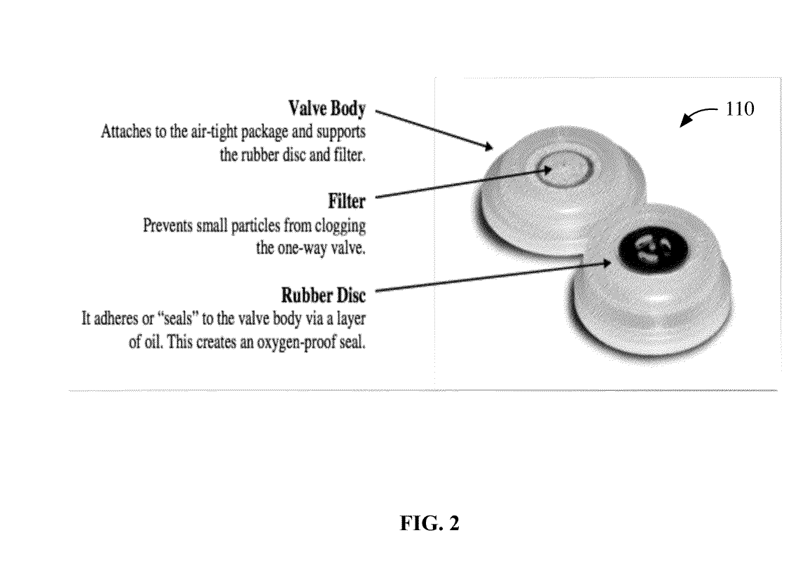

Referring now to FIG. 2 a typical one way degassing valve 110 is depicted. As shown in FIG. 2, the degassing valve comprises 3 main parts: a valve body; a filter; and a rubber disc. For the most preferred embodiments of the present invention, a filter portion that is common to many degassing valves 110 will be removed. With the filter in place, the pressure inside the heating bag may increase to the point where the zip-lock seal is compromised

One-way degassing valves 110 are designed to allow pressure to be released from an airtight package while not allowing external atmosphere (i.e. air with 20.9% O2) to enter the heating bag. In the most preferred embodiment of the present invention, degassing valves 110 are installed without a filter paper backing. This configuration is the most efficient configuration for allowing the initial burst in pressure and steam generated by the chemical reaction to be released without compromising the integrity of the seal for the heating bag.

When pressure inside a sealed package increases beyond the valve opening pressure associated with the one way valve, the rubber disk in valve 110 momentarily opens to allow gas to escape out of the heating bag. As gas is released and the pressure inside the package drops below the valve close pressure, valve 110 closes. By holding the high pressure in bag 100, this is in direct relation to holding higher than normal temperatures in the bag for an extended period of time.

Typical Valve Performance Data—open pressure: 20-70 mm H2O and close pressure: 5-45 mm H2O

Typical Quality Data on Valved Packages—Avg. % O2 after 1 year: less than 2.5% and Effectiveness rate for O2 barrier and open/close pressure: 99.9%.

Typical Rubber Dimensions: 0.34 in. dia.×0.031 in. Rubber Disk Service Temp: −50 to 220° F.

Valve Body Dimensions (+/−0.005 in.) Outer Dia.: 0.890 and Height: 0.176.

The same size bag and heating element but with steam release holes, as typically used in heating bag applications, will generally maintain an inside temperature in the vicinity of 175° F. (79° C.) for approximately 15 minutes. In comparison, the same size bag and element, but with two or three one-way degassing valves installed, will maintain the interior temperature above 175° F. (79° C.) for approximately 50 minutes. Both examples are the results of using the specified parameters when conducted at an ambient room temperature of 72° F. By comparing the results, it is possible to determine that the heating bag with the one-way degassing valves will stay hot approximately 3 times longer than the heating bag without one-way degassing valves.

In the most preferred embodiments of the present invention, water is the reacting agent. This means that each heating element will generally be contained in a sealed moisture proof foil bag. This prevents moisture from getting to the heating element prematurely, providing an isolation barrier that protects the heating element from contacting water until it is opened for use and placed in the heating bag.

The amount of food to be heated or cooked in a heating bag will dictate how large the heating bag will need to be. In addition, the size of the bag (cu. in.), the size of element, the amount of water, and the number of one-way valves in the bag are all balanced to achieve the desired level of heating for a specific application.

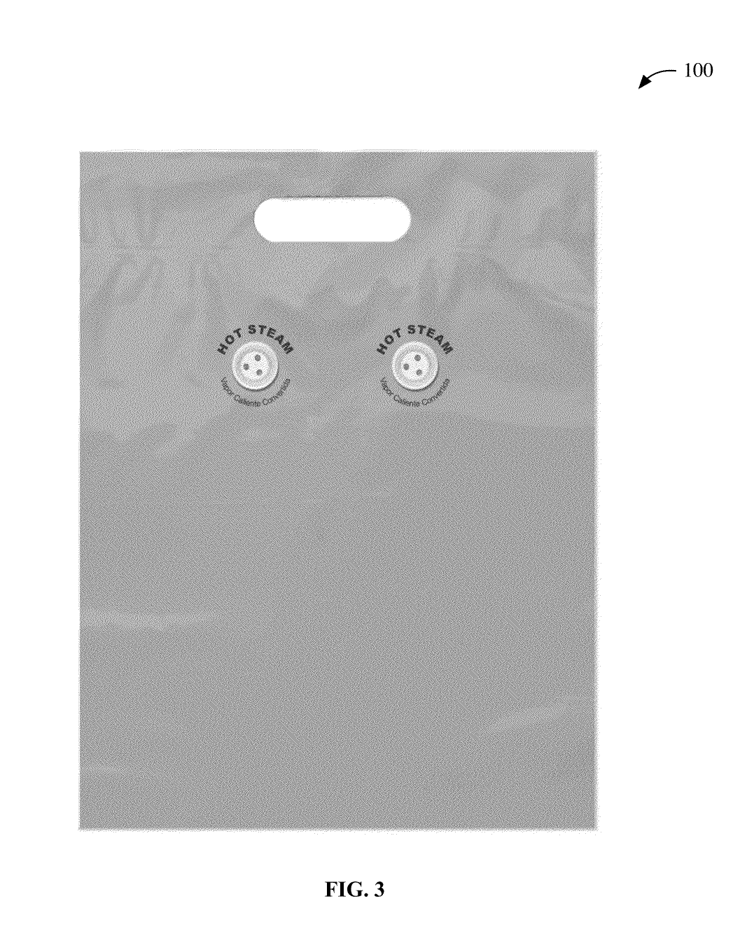

Referring now to FIG. 3, a plan view of heating bag 100 in the flat state, for storage prior to use, is depicted.

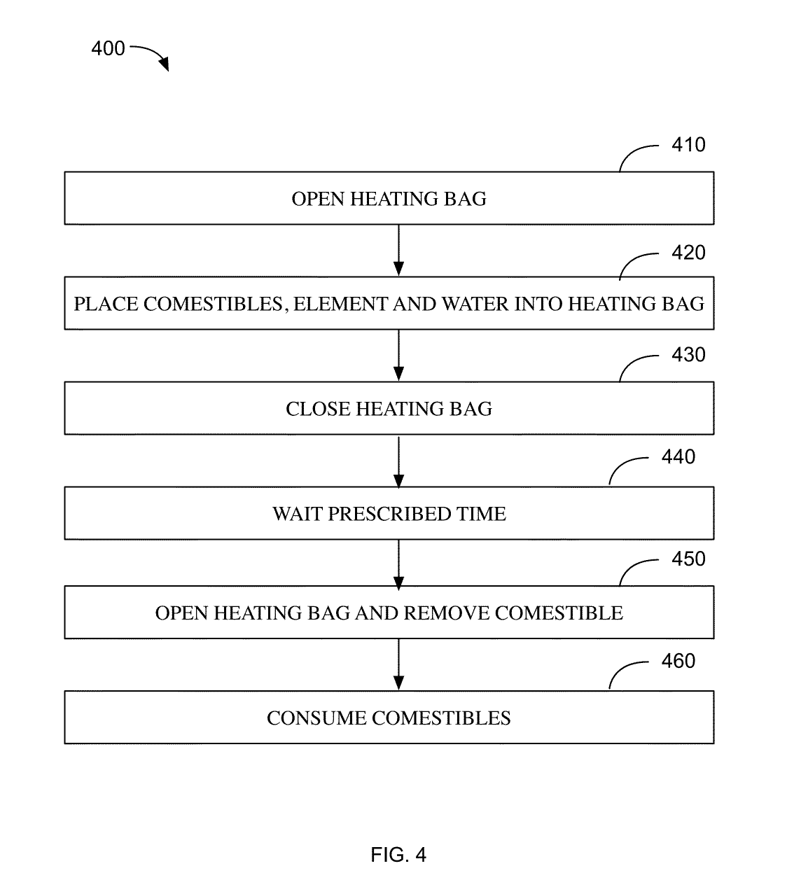

Referring now to FIG. 4, a method 400 for using a heating bag in accordance with a preferred embodiment of the present invention is depicted. One of the most common uses for a heating bag as described herein is the preparation of comestibles when traditional heating and cooking sources (e.g. stoves, ovens, grills, etc.) are not available.

To start, the heating bag is opened (step 410) and the comestible, heating element, and water are placed into the bag (step 420). The heating bag is closed (step 430) and the comestible is allowed to remain inside the heating bag for the prescribed period of time (step 440). Then, the heating bag can be opened (step 450) and the comestible can be consumed (step 460).

From the foregoing description, it should be appreciated that a unique system and method for heating and cooking food in a bag is provided by the various preferred embodiments of the present invention and that the various preferred embodiments offer significant benefits that would be apparent to one skilled in the art. For example, those skilled in the art will understand that additional preferred embodiments of the element and bag, as well as the methods described herein could be readily adapted for use in other heating applications as well. For example, additional items such as a coffee cup, a heating pad, a blanket, a coffee bag, cooking pans, warming trays, etc. could be manufactured using the heating element and chemical reaction described in this disclosure.

Furthermore, while multiple preferred embodiments have been presented in the foregoing description, it should be appreciated that a vast number of variations in the preferred embodiments exist. Lastly, it should be appreciated that these embodiments are preferred exemplary embodiments only and are not intended to limit the scope, applicability, or configuration of the invention in any way. Rather, the foregoing detailed description provides those skilled in the art with a convenient road map for implementing a preferred exemplary embodiment of the invention, it being understood that various changes may be made in the function and arrangement of elements described in the exemplary preferred embodiment without departing from the spirit and scope of the invention as set forth in the appended claims.

1. A system for heating items, the system comprising:
a heating bag;
a heating element placed within an interior space of the heating bag, the interior space of the heating bag defining a volume, the heating element comprising:
powdered aluminum;
calcium oxide;
calcium carbonate;
calcium dihydroxide;
sodium carbonate; and
sodium hydroxide;
an effective quantity of water inserted into the interior space of the heating bag, the water contacting and reacting with the heating element to create a multi-stage chemical reaction; and
at least one item to be heated being inserted into the interior space of the heating bag.

2. The system of claim 1 wherein the resealable heating bag comprises at least one degassing valve, the at least one degassing valve regulating the pressure of the interior space of the resealable heating bag.

3. The system of claim 1 wherein the heating element comprises, by weight:
30% to 45% powdered aluminum;
10% to 20% powdered calcium oxide;
15% to 25% powdered calcium carbonate;
10% to 15% calcium dihydroxide;
10% to 15% powdered sodium carbonate;
and 0.1% to 1% of sodium hydroxide.

4. The system of claim 1 where the resealable heating bag comprises a plurality of degassing valves and wherein each of the plurality of degassing valves comprises:
a valve body;
a filter; and
a rubber disc.

5. The system of claim 1 wherein the multi-stage chemical reaction comprises:
a first stage reaction wherein the effective amount of water reacts with the powdered calcium oxide to generate heat of reaction; and
a secont stage reaction wherein the calcium hydroxide, calcium dihydroxide, powdered sodium carbonate, and sodium hydroxide react with the powdered aluminum to generate heat of reacton.

6. The system of claim 1 wherein:
the heating bag comprises a plurality of degassing valves; and
wherein the heating element comprises, by weight:
30% to 45% powdered aluminum;
10% to 20% powdered calcium oxide;
15% to 25% powdered calcium carbonate;
10% to 15% calcium dihydroxide;
10% to 15% powdered sodium carbonate; and
0.1% to 1% of sodium hydroxide.

7. The system of claim 1 where the resealable heating bag comprises a plurality of degassing valves based on the volume of the interior space of the resealable heating bag.

8. The system of claim 1 where the volume of the interior space of the resealable heating bag is related to a plurality of degassing valves based on the volume of the interior space of the heating bag.

9. A heating element comprising effective amounts of:
powdered aluminum;
calcium oxide;
calcium carbonate;
calcium dihydroxide;
sodium carbonate; and
sodium hydroxide.

10. The heating element of claim 9 wherein the effective amounts comprise, by weight:
30% to 45% powdered aluminum;
10% to 20% powdered calcium oxide;
15% to 25% powdered calcium carbonate;
10% to 15% calcium dihydroxide;
10% to 15% powdered sodium carbonate;
and 0.1% to 1% of sodium hydroxide.

11. The heating element of claim 9 wherein the heating element is contacted with an effective amount of water to create a multi-stage chemical reaction.

12. The heating element of claim 9 wherein the heating element generates steam and heat and wherein at least a portion of the heat and steam is expelled through a plurality of degassing valves.

13. A method for heating an item, the method comprising the steps of:
placing a heating element into an interior space within a resealable heating bag, the heating element comprising:
powdered aluminum;
calcium oxide;
calcium carbonate;
calcium dihydroxide;
sodium carbonate; and
sodium hydroxide;
placing the item to be heated into the interior space of the resealable heating bag;
contacting the heating element with an effective amount of water, thereby inducing a multi-stage chemical reaction, the multi-stage chemical reaction generating heat and steam;
sealing the resealable heating bag;
waiting for a prescribed period time to allow the item to be heated by the heat and steam.

14. The method of claim 13 where the resealable heating bag comprises at least one degassing valve, the at least one degassing valve regulating the pressure of the interior space of the resealable heating bag.

15. The method of claim 13 wherein the heating element comprises, by weight:
30% to 45% powdered aluminum;
10% to 20% powdered calcium oxide;
15% to 25% powdered calcium carbonate;
10% to 15% calcium dihydroxide;
10% to 15% powdered sodium carbonate;
and 0.1% to 1% of sodium hydroxide.

16. The method of claim 13 where the resealable heating bag comprises a plurality of degassing valves and wherein each of the plurality of degassing valves comprises:
a valve body;
a filter; and
a rubber disc.

17. The method of claim 13 further comprising the steps of:
selecting a heating element size based on a volume defined by the interior space of the resealable heating bag; and
selecting a number of degassing valves to be installed in the resealable heating bag based on the interior space of the resealable heating bag.
